(19) United States
(12) Patent Application Publication
(10) Pub. No.: US 2005/0027380 A1
(43) Pub. Date: Feb. 3, 2005

(54) Monitoring procedure for a control of an injection-molding process

(76) Inventors: Hubert Bellm, Stutensee (DE); Herbert Grieb, Malsch (DE); Klaus Oberndorfer, Erlangen (DE); Manfred Zah, Forchheim (DE)

Correspondence Address: WHITE & CASE LLP;PATENT DEPARTMENT, 1155 AVENUE OF THE AMERICAS, NEW YORK, NY, 10036, US

(21) Appl. No.: 10/804,885

(22) Filed: Mar. 18, 2004

(30) Foreign Application Priority Data
Mar. 19, 2003 (DE) 103 12 256.7

(51) Int. Cl. G05B 9/02

(52) U.S. Cl. 700/79

(57) ABSTRACT

Monitoring procedure for a control (2) of an injection-molding process, actual values (T, p, n, v) of the injection-molding process being acquired and fed to a computer (16), the actual values (T, p, n, v) being acquired by the control (2) and transmitted to the computer (16).

The present invention relates to a monitoring procedure for a control of an injection-molding process, whereby actual values of the injection-molding process are acquired and fed to a computer.

Such monitoring procedures are generally known.

For example, today there are a large number of software tools available for performing process monitoring and optimization as higher-level functions complementing the control of an injection-molding machine. Each of these tools requires as input data the variation over time of relevant process variables, for example the pressure, speed, variation in temperature, etc. On the basis of the variation over time of the relevant process variables, the tools carry out, for example, optimization algorithms and in this way supply new setpoint values for the control of the injection-molding process, for example a new speed profile or pressure profile. The new setpoint values are then transferred from the tool via an interface into the control.

The tools usually run on PC hardware under a PC operating system. The actual values are acquired by dedicated sensors and fed to the PC via a corresponding peripheral module. The process signals are consequently picked up by the computer directly from the injection-molding machine and recorded in the PC as measuring curves.

The object of the present invention is to allow the actual values to be fed to the computer in a more simple, lower-cost and, in particular, more universal manner.

The object is achieved by the actual values being acquired by the control and transmitted to the computer.

Consequently, dedicated sensors that are only used for the monitoring procedure are not employed in the present case; instead shared use is made of the control's sensor systems.

It is possible that, in the monitoring procedure, the actual values are used only for trend analyses, operating data acquisition and/or machine data acquisition. Preferably, however, the monitoring procedure includes that, by evaluating the transmitted actual values, the computer determines at least one setpoint value and transmits it to the control. Consequently, the monitoring procedure preferably also performs an optimization of the control. The setpoint value may in this case be a single value, for example a final temperature to be reached directly before the injection of the polymer into the injection mold, or a setpoint profile, for example the corresponding variation in temperature.

The computer generally takes the form of a PC. Therefore, the control is particularly simple and convenient if, virtually in parallel with the execution of the monitoring procedure, the computer receives inputs for the control from an operator and passes them on to the control and/or receives outputs for the operator from the control and passes them on to the operator.

The receiving and passing on of the inputs and/or outputs is preferably executed by the computer under an operating system which does not have real-time capability.

The execution of the monitoring procedure may likewise be performed under an operating system which does not necessarily have to have real-time capability.

Modern controls are in the meantime likewise realized on the basis of PC hardware and PC operating systems. It is consequently possible for the control to take the form of a software process which is executed by the computer under an operating system with real-time capability virtually in parallel with the execution of the monitoring procedure.

Further advantages and details emerge from the following description of an exemplary embodiment in conjunction with the drawings, in which, in a basic representation:

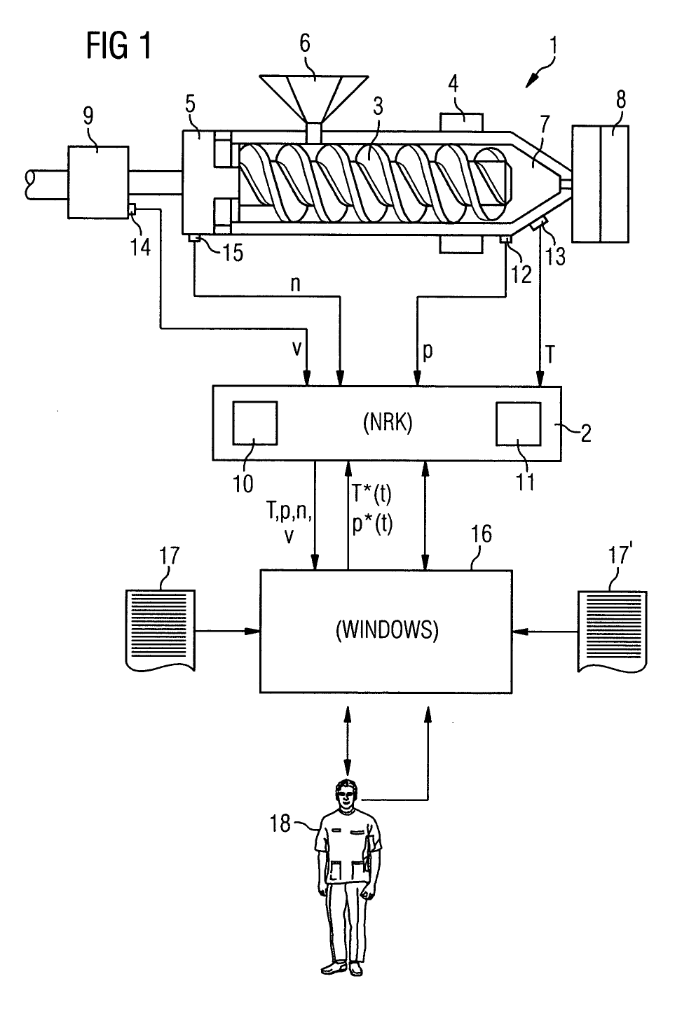

FIG. 1 shows an injection-molding machine with a control and a computer; and

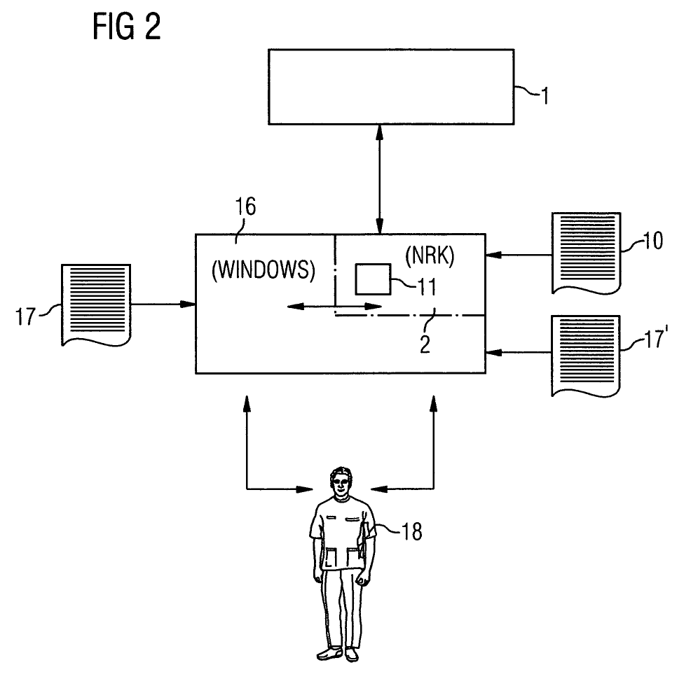

FIG. 2 shows a computer.

An injection-molding machine 1 is controlled according to FIG. 1, by a control 2. The injection-molding machine 1 is constructed in a conventional way and is operated in a conventional way. It consequently has a screw 3 and a heater 4. The screw 3 is turned by a motor 5. It conveys pellets (not represented), which are fed via a hopper 6, into a space 7 in front of the screw. The pellets are heated by means of the heater 4 and thereby heated and plasticized. The plasticized pellets are then conveyed by means of the screw 3 from the space 7 in front of the screw into an injection mold 8. For this purpose, the screw 3 is displaced in the axial direction by means of a feed drive 9. Then, the plasticized pellets are left to cool and solidify in the injection mold 8. After that, the sequence of steps described above is repeated.

The control 2 controls the entire injection-molding process described above. For this purpose, on the one hand a control program 10 and on the other hand setpoint profiles 11 are stored in the control 2. The setpoint profiles 11 represent, in particular, variations over time to be maintained for the temperature T of the pellets in the space 7 in front of the screw, the feed rate v of the screw 3 and the pressure p in the space 7 in front of the screw or in the injection mold 8.

The control 2 is connected via corresponding control lines to the heater 4, the motor 5 and the feed drive 9, that is to the actuators of the plastics injection-molding machine 1. It is also connected to sensors 12-15. The sensors 12-15 transmit to the control 2 actual values of the injection-molding process. For example, the sensor 12 acquires—directly or indirectly—the pressure p prevailing in the space 7 in front of the screw. The sensor 13 acquires the temperature T prevailing in the space 7 in front of the screw. The sensor 14 acquires the feed rate v. The sensor 15 acquires for example a rotational speed n, with which the screw 3 is rotating. These actual values p, T, v, n are used internally by the control 2 for controlling the injection-molding process.

The control 2 also communicates with a computer 16, which is at least temporarily assigned to the plastics injection-molding machine 1. The computer 16 runs a monitoring procedure for the control 2. The monitoring procedure is in this case realized by a computer program 17, with which the computer 16 is programmed. The computer program 17 is executed by the computer 16 usually under an operating system which does not have real-time capability, for example Windows®. While executing the monitoring procedure, the computer 16 receives the actual values T, v, p, n from the control 2. The actual values T, v, p, n are consequently transmitted by the control to the computer 16. In the monitoring procedure, the computer 16 evaluates the transmitted actual values T, v, p, n. It also determines—if appropriate by communication with an operator 18—at least one setpoint value, for example a temperature profile T*(t) or a pressure profile p*(t). It then transmits the setpoint value T*(t), p*(t) determined to the control 2.

Virtually in parallel with the execution of the monitoring procedure, the computer 16 also receives from the operator 18 inputs for the control 2 and passes them on to the control 2. Furthermore, it also receives outputs for the operator 18 from the control 2 and passes them on to the operator 18. The receiving and passing on of the inputs and/or outputs is executed by the computer 16 on the basis of the programming with a further computer program 17′. It is preferably executed by the computer 16 under the same operating system as the monitoring procedure. However, it can also be executed under another operating system.

On the part of the control 2, the receiving and executing of the inputs and/or outputs is performed under an operating system with real-time capability. An example of such an operating system with real-time capability is the Siemens® NRK.

FIG. 2 then shows a modification of the control 2. According to FIG. 2, the control 2 takes the form of a software process 2. The software process 2 is executed by the computer 16 virtually in parallel with the execution of the monitoring procedure under an operating system with real-time capability. In the case of the embodiment according to FIG. 2, consequently, direct control of the plastics injection-molding machine 1 from the computer 16 is possible.

1-9. (canceled)

10. A method for monitoring a control for an injection-molding process, the method comprising the steps of:
(a) acquiring, using the control, actual values of at least one process variable of the injection-molding process, the actual values of the at least one process variable comprising at least one selected from the group consisting of temperature, pressure, feed rate, and rotational speed; and
(b) transmitting the actual values of the at least one process variable to a computer for monitoring the control.

11. The method according to claim 10, further comprising the steps of evaluating the transmitted actual values with the computer, determining at least one setpoint value, and transmitting the at least one setpoint value to the control.

12. The method according to claim 10, further comprising the step of receiving at the computer at least one input from an operator and sending the received at least one input to the control virtually in parallel with the execution of the monitoring of the injection-molding process.

13. The method according to claim 10, further comprising the step of receiving at the computer at least one output from the control and sending the received at least one output to an operator virtually in parallel with the execution of the monitoring of an injection-molding process.

14. The method according to claim 12, wherein receiving and sending the at least one input is executed by the computer under an operating system comprising non-real-time capabilities.

15. The method according to claim 13, wherein receiving and sending the at least one output is executed by the computer under an operating system comprising non-real-time capabilities.

16. The method according to claim 10, wherein the control comprises a software process, the software process executed by the computer under an operating system comprising real-time capability, the software process executing virtually in parallel with transmitting the actual values acquired by the control to the computer for monitoring.

17. The method according to claim 10, wherein the monitoring is carried out using a computer program, the computer program executed on the computer.

18. A system for controlling an injection-molding machine having an operator and comprising a plurality of sensors for transmitting values associated with an injection-molding process, the system comprising:
(a) a control for the injection-molding machine in communication with the plurality of sensors, the control having at least one input and at least one output, the transmitted values associated with the injection-molding process and received by the at least one input; and
(b) a computer in communication with the control and receiving the transmitted values associated with the injection-molding process from the at least one output associated with the control, wherein the computer monitors the received values associated with the injection-molding process virtually in parallel with receiving at least one input from the operator.

19. The system according to claim 18, wherein the at least one input receives the transmitted values in real time, and wherein the computer receives the transmitted values from the at least one output in real time.

20. The system according to claim 18, wherein the computer is configured for receiving at least one operator input and for passing the at least one operator input to the control.

21. The system according to claim 18, wherein the computer comprises a first computer program for monitoring the received values associated with the injection-molding process and a second computer program for sending at least one output received from the control to the operator, and wherein the second computer program sends at least one input received from the operator to the control.

22. The system according to claim 21, wherein at least one of the first computer program and the second computer program run on a non-real-time operating system.

23. The system according to claim 18, wherein the control comprises a real-time operating system.

24. A computer for controlling and monitoring an injection-molding machine having associated therewith a plurality of sensors for transmitting values of process variables associated with an injection-molding process, the computer comprising:
(a) a first computer program for executing a software process for controlling the injection-molding process; and
(b) a second computer program for executing a monitoring procedure based on the transmitted values associated with the injection-molding process.

25. The computer according to claim 24, wherein the monitoring procedure and the software process are executed in parallel.

26. The computer according to claim 24, wherein the computer has an operator, the computer further comprising a third computer program for sending at least one input received from the operator to the first computer program executing the software process.

27. The computer according to claim 24, wherein the computer has an operator, the computer further comprising a third computer program for receiving from the first computer program at least one output for the operator.

28. The computer according to claim 24, wherein the first and second computer programs are executed under an operating system having real-time capability.

29. The computer according to claim 24, wherein the process variables associated with the injection-molding process comprise at least one of the group consisting of temperature, pressure, speed, and feed rate.

30. The computer according to claim 24, further comprising stored setpoint values, wherein the setpoint values comprise at least one of the group consisting of temperature variations, pressure variations, and feed rate variations.

31. A method of monitoring an injection-molding process associated with an injection-molding machine by utilizing a control, the control in communication with a plurality of sensors, the method comprising the steps of:
(a) executing a monitoring procedure based on receiving data from the plurality of sensors; and
(b) receiving at the control virtually in parallel to executing the monitoring procedure at least one input from an operator.

32. The method according to claim 31, wherein the monitoring procedure is carried out by a computer associated with the control.

33. The method according to claim 31, further comprising the step of: (c) sending at least one output from the control to the operator virtually in parallel to executing the monitoring procedure.

34. The method according to claim 31, wherein the at least one first input from the plurality of sensors comprises at least one of the group consisting of temperature, pressure, speed, and feed rate.

35. The method according to claim 31, wherein the monitoring procedure further comprises evaluating the received at least one first input from the plurality of sensors and determining at least one setpoint value based on the received at least one first input from the plurality of sensors.

36. The method according to claim 31, wherein the determined at least one set point value is sent to the control.

37. The method according to claim 36, wherein the at least one set point value comprises at least one of the group consisting of temperature variations, pressure variations, and feed rate variations.

38. A control system for an injection-molding machine, the control comprising:
(a) a plurality of sensors for sensing and transmitting values associated with the injection-molding process;
(b) a control in communication with the plurality of sensors; and
(c) a computer in communication with the control, wherein the transmitted values associated with the plurality of sensors are shared by both the control and the computer.

39. The system according to claim 38, wherein the plurality of sensors are not dedicated solely for use with the computer.
